(19) United States
(12) Patent Application Publication
(10) Pub. No.: US 2015/0205523 A1
(43) Pub. Date: Jul. 23, 2015

(54) Sliding Magnified Selector for Touch Screen Keyboards

(71) Applicant: Charles Albert Morris, Maquoketa, IA (US)

(72) Inventor: Charles Albert Morris, Maquoketa, IA (US)

(21) Appl. No.: 14/599,399

(22) Filed: Jan. 16, 2015

Related U.S. Application Data
(60) Provisional application No. 61/929,004, filed on Jan. 17, 2014.

(51) Int. Cl. G06F 3/0488; G06F 3/0482

(52) U.S. Cl. CPC G06F 3/04886; G06F 3/0482

(57) ABSTRACT

A touch screen keyboard in which one of the user's digits maintains contact with the touch screen, sliding across the screen below the keyboard with a magnifying cursor reaching upward from the digit onto the keyboard, enlarging one key at a time. The enlarged key is engaged when the user taps the screen anywhere else with another digit. Alternate configurations use fixed graphical buttons or accelerometer detected tapping for engagement of the enlarged key.

### BACKGROUND OF THE INVENTION

The present invention relates to implementation of a virtual keyboard on a touch screen.

In both U.S. Pat. No. 8,826,187 and U.S. Pat. No. 7,489,306 a finger maintains contact with a touch screen and a cursor pointer extends from the finger to an object that a user would like to select. Once the pointer is over the object, a second or more targets or buttons are displayed that the user can touch to engage the object. Whereas, these inventions gives the user more controlled selection of objects, they requires the user to carefully point to and hit a second target or button that is arrayed around the pointing cursor. In the present invention, the user is not required to point to and hit a target or button that moves with a pointing cursor. Rather, the user can carelessly tap anywhere else with a second digit to engage the key to which the cursor is pointing, said key being graphically enlarged and highlighted to clearly indicate the key that is ready to be engaged. Furthermore, these two patents lack the present patent's innovation of assigning an area completely away from the virtual keyboard where the user's first digit touches. This innovation keeps the keyboard entirely visible to the user at all times, making it easier to recognize desired keys.

In both U.S. Pat. No. 6,067,079 and U.S. Pat. No. 7,737,954, a cursor pointer points to objects that are at a distance from the finger that is touching the touch screen, and the user can select an object by temporarily lifting the finger off the touch screen. The present invention allows the user to maintain contact with the touch screen, which offers greater stability. If U.S. Pat. No. 6,067,079 or U.S. Pat. No. 7,737,954 were to be used in a keyboard, a much slower process would be required compared to the present invention. Rather than almost simultaneously selecting with one finger and engaging with another, as in the present invention, each key engagement would require a lifting motion once the user was pointing to a key, then the finger would be returned to the touch screen, and the user would have to see where the finger landed, adjust accordingly and move to the next desired key.

In U.S. Patent # 20110122081 the user's finger maintains contact with the touch screen and swipes across a keyboard from key to key generating a path that can be interpreted in order to predict the word that the user means to type. Such predictive methods are prone to errors and do not offer the controlled data entry that the present invention provides.

It would be advantageous to provide a touch screen keyboard in which one of the user's digits maintains contact with the touch screen, sliding across the screen below the keyboard with a magnifying cursor reaching upward from the digit onto the keyboard, enlarging one key at a time, with the enlarged key being engaged when the user taps the screen anywhere else with another digit. It would be advantageous to further provide alternate configurations that use fixed graphical buttons or accelerometer detection of tapping on the touch screen's housing for engagement of the enlarged key. Such a keyboard can be made exceptionally small and only needs to be legible, so a standard desktop keyboard layout can be used on a smart phone, and a fully controllable keyboard can be implemented on a smart watch. The present invention provides a touch screen keyboard that remains entirely visible to the user at all times, so the user does not have to move his or her finger out of the way after engaging a key in order to see where the next key is. In comparison to keyboards that use swiping from key to key to guess what the user intends to type, the present invention allows users to clearly select specific keys, rather than leaving this task up to imperfect predictive software.

### BRIEF SUMMARY OF THE INVENTION

It is an object of the invention to provide a smartphone touch screen keyboard that allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit anywhere else on the touch screen.

It is an object of the invention to provide a modified form of construction in which a tablet computer touch screen keyboard allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit on one of five graphical buttons that are fixed in place on the touch screen: a check button for standard engagement, a shift button, an alt button, a control button, and a caps lock button.

It is an object of the invention to provide a modified form of construction in which a remote control touch screen keyboard allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit anywhere on the remote control, with an accelerometer detecting and registering the tap.

It is an object of the invention to provide a modified form of construction in which a smart watch touch screen keyboard allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit anywhere on the smart watch, with an accelerometer detecting and registering the tap.

### BRIEF DESCRIPTION OF THE SEVERAL VIEWS OF THE DRAWING

The present invention will be more fully understood by reference to the following detailed descriptions thereof when read in conjunction with the attached drawings, and wherein:

FIG. 1 is a perspective view of a preferred embodiment of a smartphone touch screen keyboard that allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit anywhere else on the touch screen; and

FIG. 2 is a perspective view of a yet further modified form of construction with a tablet computer touch screen keyboard that allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit on one of five graphical buttons that are fixed in place on the touch screen: a check button for standard engagement, a shift button, an alt button, a control button, and a caps lock button; and

FIG. 3 is a perspective view of an even further modified form of construction with a remote control touch screen keyboard that allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit anywhere on the remote control, with an accelerometer detecting and registering the tap; and

FIG. 4 is a perspective view of an even yet further modified form of construction with a smart watch touch screen keyboard that allows users to maintain contact with the touch screen on an area below the keyboard, touching with a finger or a thumb the base of a graphical movable magnifying glass that extends upward onto the keyboard enlarging one key at a time, indicating that the enlarged key is ready to be engaged. The user slides the finger or thumb around below the keyboard, moving the magnifying glass from key to key. Engagement of the enlarged key only occurs when the user taps with another digit anywhere on the smart watch, with an accelerometer detecting and registering the tap; and

FIG. 5 is a flow chart showing illustrative steps that may be taken to actuate a keystroke through detection of a second finger tapping anywhere on the screen; and

FIG. 6 is a flow chart showing illustrative steps that may be taken to actuate a keystroke through accelerometer detection of a second finger tapping the device.

### DETAILED DESCRIPTION OF THE INVENTION

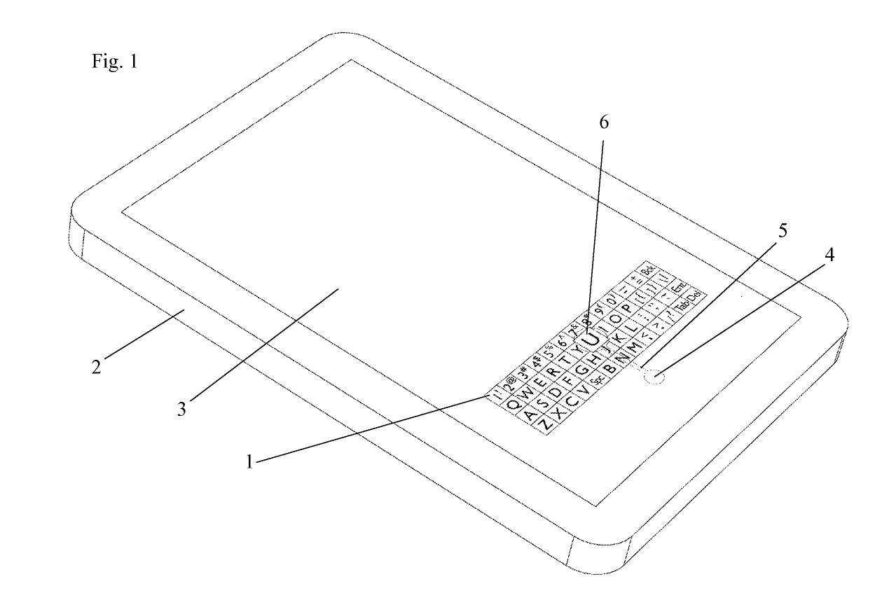

In FIG. 1, there is shown a perspective view of an example of the touch screen keyboard 1 on a smartphone 2 that allows users to maintain contact with the touch screen 3, touching with a finger or a thumb the base 4 of a graphical movable magnifying glass 5 that extends upward onto the touch screen keyboard 1 enlarging one key at a time, indicating that the enlarged key 6 is ready to be engaged. The user slides the finger or thumb around below the touch screen keyboard 1, moving the magnifying glass 5 from key to key. Engagement of the enlarged key 6 only occurs when the user taps with another digit anywhere else on the touch screen 3; and

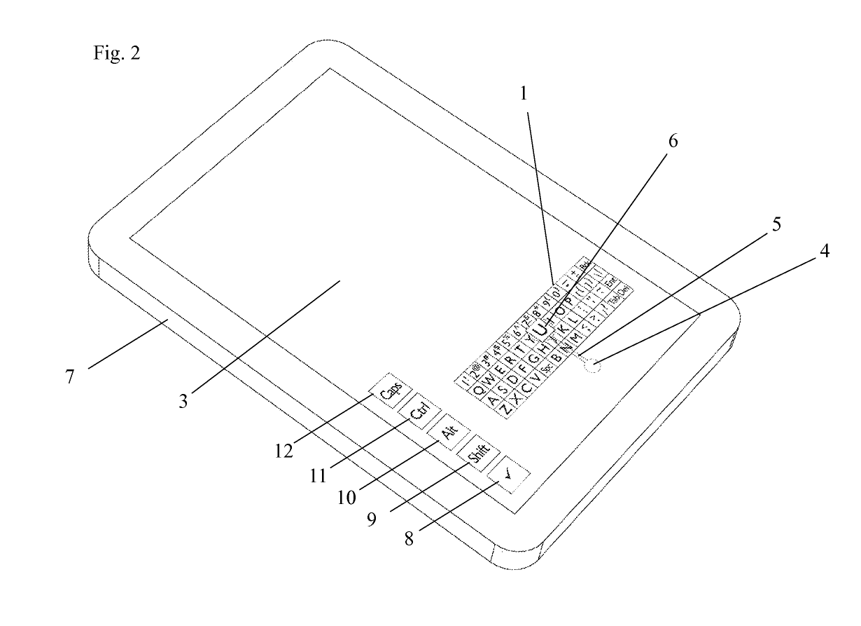

In FIG. 2, there is shown a perspective view of a further example of the touch screen keyboard 1 on a tablet computer 7 that allows users to maintain contact with the touch screen 3, touching with a finger or a thumb the base 4 of a graphical movable magnifying glass 5 that extends upward onto the touch screen keyboard 1 enlarging one key at a time, indicating that the enlarged key 6 is ready to be engaged. The user slides the finger or thumb around below the touch screen keyboard 1, moving the magnifying glass 5 from key to key. Engagement of the enlarged key 6 only occurs when the user taps with another digit on one of five graphical buttons 8-12 that are fixed in place on the touch screen: a check button 8 for standard engagement, a shift button 9 for shifted engagement, an alt button 10 for an alt engagement, a control button 11 for a control engagement, and a caps lock button 12; and

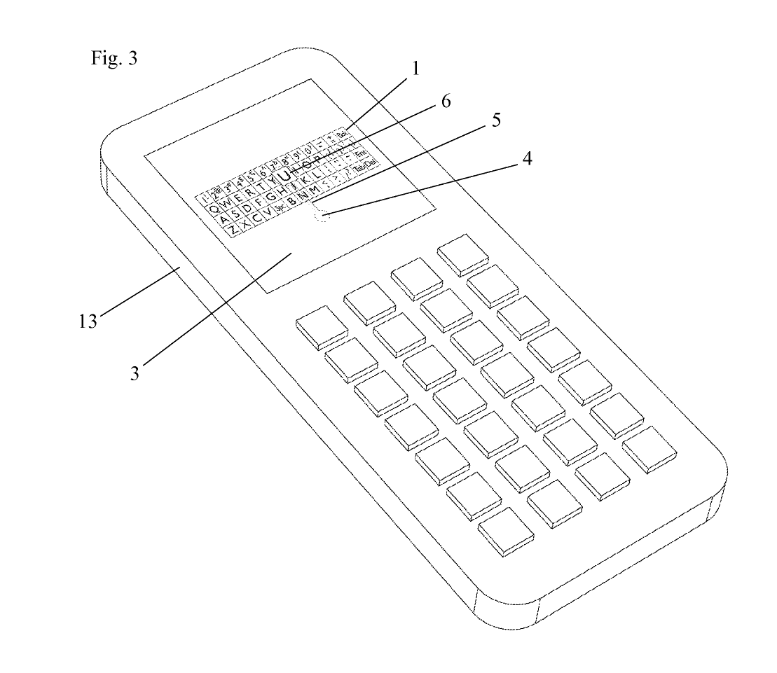

In FIG. 3, there is shown a perspective view of a further example of the touch screen keyboard 1 on a remote control device 13 that allows users to maintain contact with the touch screen 3, touching with a finger or a thumb the base 4 of a graphical movable magnifying glass 5 that extends upward onto the keyboard enlarging one key at a time, indicating that the enlarged key 6 is ready to be engaged. The user slides the finger or thumb around below the touch screen keyboard 1, moving the magnifying glass 5 from key to key. Engagement of the enlarged key 6 only occurs when the user taps with another digit anywhere on the remote control device 13, with an accelerometer detecting and registering the tap; and

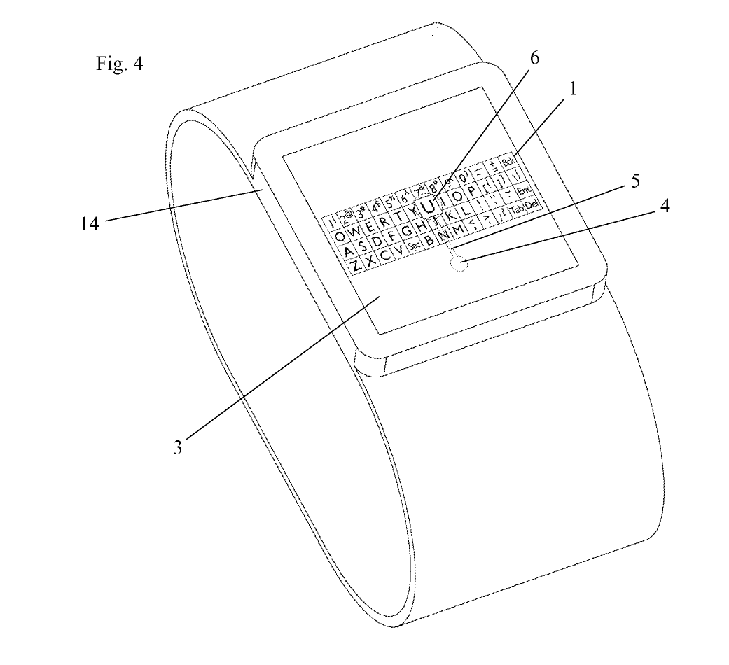

In FIG. 4, there is shown a perspective view of a further example of the touch screen keyboard 1 on a smart watch 14 that allows users to maintain contact with the touch screen 3, touching with a finger or a thumb the base 4 of a graphical movable magnifying glass 5 that extends upward onto the touch screen keyboard 1 enlarging one key at a time, indicating that the enlarged key 6 is ready to be engaged. The user slides the finger or thumb around below the touch screen keyboard 1, moving the magnifying glass 5 from key to key. Engagement of the enlarged key 6 only occurs when the user taps with another digit anywhere on the smart watch 14, with an accelerometer detecting and registering the tap.

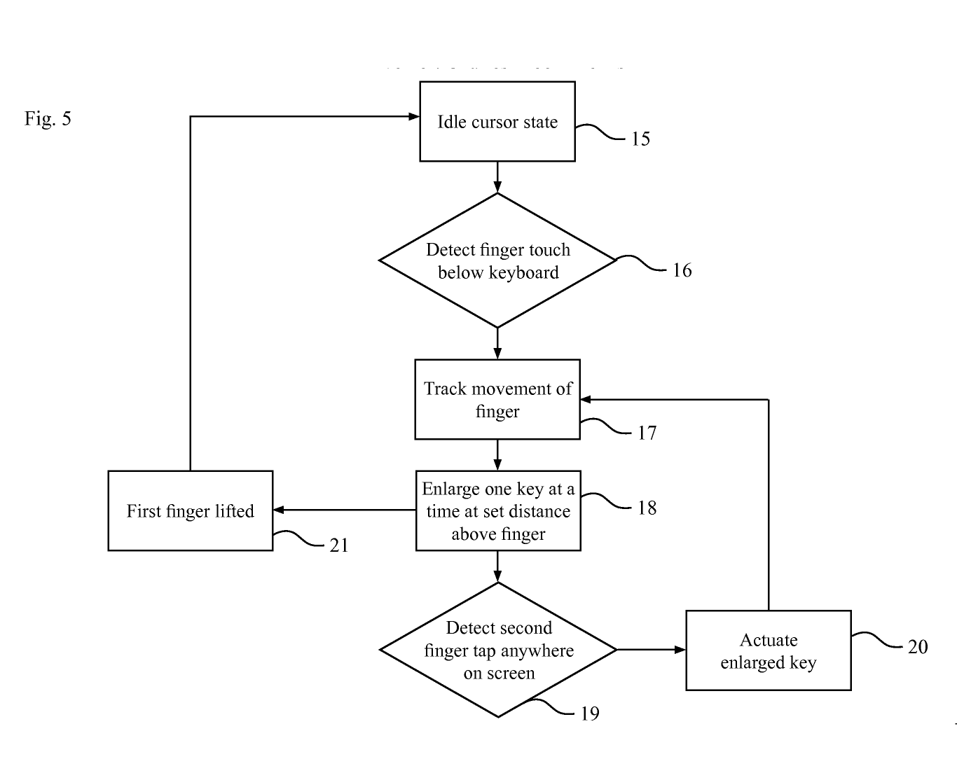

FIG. 5 is a flow chart showing illustrative steps that may be taken to actuate a keystroke through detection of a second finger tapping anywhere on the screen. After an idle cursor state (step 15) in which no fingers are touching the touch screen, the touch screen detects a finger touch in the space below the virtual keyboard (step 16) and begins to track the movements across the touch screen of the finger (step 17), graphically enlarging one key at a time at a set distance above the finger (step 18). When the touch screen detects a second finger tap anywhere on the screen (step 19), whichever key is enlarged at the moment of the second finger's tap is actuated (step 20). When the first finger is lifted off the touch screen (step 21), the device returns to an idle cursor state (step 15).

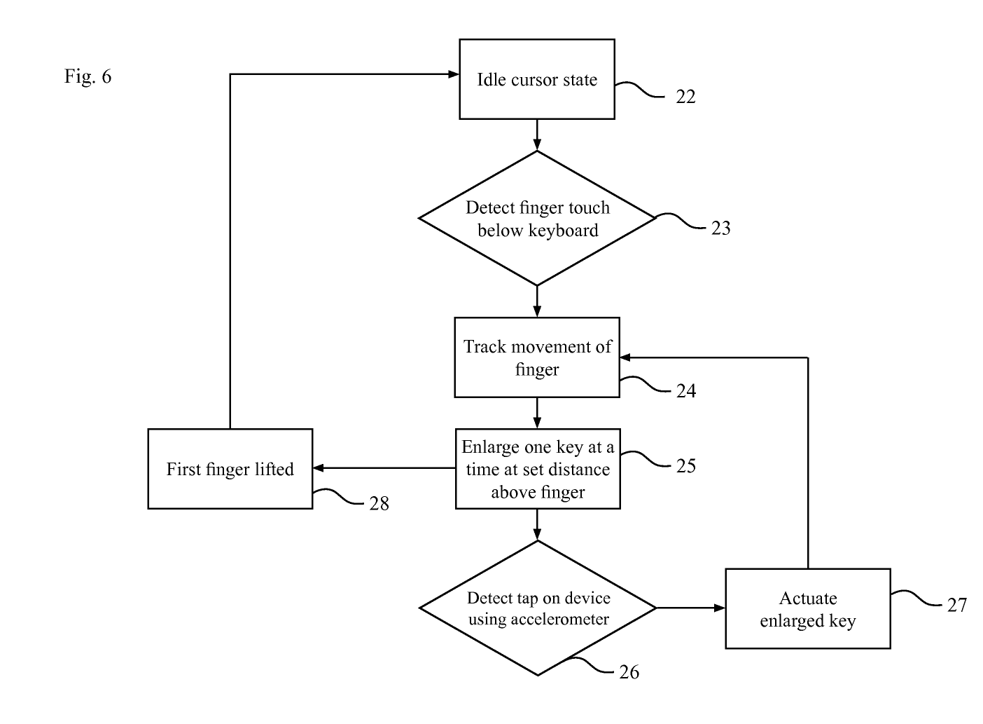

FIG. 6 is a flow chart showing illustrative steps that may be taken to actuate a keystroke through accelerometer detection of a second finger tapping the device. After an idle cursor state (step 22) in which no fingers are touching the touch screen, the touch screen detects a finger touch in the space below the virtual keyboard (step 23) and begins to track the movements across the touch screen of the finger (step 24), graphically enlarging one key at a time at a set distance above the finger (step 25). When the device is tapped by a second digit, the accelerometer in the device detects the tap (step 26), and whichever key is enlarged at the moment the device is tapped is actuated (step 27). When the first finger is lifted off the touch screen (step 28), the device returns to an idle cursor state (step 22).

I claim:

1. A virtual graphical keyboard for a touch screen consisting of multiple graphical onscreen keys and including in combination:
means for tracking the position of a first digit of a hand of a user as it maintains contact with and slides across a portion of said touch screen away from said virtual graphical keyboard;
means for graphically enlarging said keys of said virtual graphical keyboard, one at a time and at a fixed distance and fixed angle from said first digit in order to indicate to said user a key ready to be engaged;
means for graphically highlighting said key ready to be engaged;
means for engaging said key ready to be engaged when said user taps anywhere on said touch screen with at least one other digit; and
means for momentarily graphically altering said key ready to be engaged to indicate that engagement has occurred.

2. The combination according to claim 1 wherein tapping with more than one of said user's said at least one other digit provides an alternate command related to said key ready to be engaged.

3. The combination according to claim 1 wherein at least one graphical touch-sensitive button for the engagement of said key ready to be engaged is located in a fixed position away from said virtual graphical keyboard.

4. The combination according to claim 1 wherein said portion of said touch screen said first digit of a hand of a user maintains contact with and slides across is located below said virtual graphical keyboard.

5. The combination according to claim 1 wherein said virtual graphical keyboard can be swiped across by a digit of said user's hand to select at least one alternate set of commands for said graphical onscreen keys.

6. The combination according to claim 1 wherein said touch screen is built into a tablet computer.

7. The combination according to claim 1 wherein said touch screen is built into a multi-touch computerized display surface.

8. The combination according to claim 1 wherein said touch screen is built into a smartphone.

9. The combination according to claim 1 wherein said touch screen is built into a remote control device.

10. The combination according to claim 1 wherein said touch screen is built into a smart watch.

11. The combination according to claim 1 wherein a graphical magnifying glass cursor extends from said first digit of a hand of a user to said key ready to be engaged, and wherein said graphical magnifying glass cursor has a graphical button at the end that is beneath said first digit of a hand of a user.

12. The combination according to claim 1 wherein each time said user lifts said first digit of a hand of a user from said touch screen a space bar command is engaged.

13. A virtual graphical keyboard for a touch screen consisting of multiple graphical onscreen keys and including in combination:
means for tracking the position of a first digit of a hand of a user as it maintains contact with and slides across a portion of said touch screen away from said virtual graphical keyboard;
means for graphically enlarging said keys of said virtual graphical keyboard, one at a time and at a fixed distance and fixed angle from said first digit in order to indicate to said user a key ready to be engaged;
means for graphically highlighting said key ready to be engaged;
means for engaging said key ready to be engaged when said user taps anywhere, including on said touch screen and on a housing for said touch screen with at least one other digit, said taps anywhere being detected by a vibration sensor such as an accelerometer; and
means for momentarily graphically altering said key ready to be engaged to indicate that engagement has occurred.

14. The combination according to claim 13 wherein tapping with more than one of said user's said at least one other digit provides an alternate command related to said key ready to be engaged.

15. The combination according to claim 13 wherein a graphical magnifying glass cursor extends from said first digit of a hand of a user to said key ready to be engaged, and wherein said graphical magnifying glass cursor has a graphical button at the end that is beneath said first digit of a hand of a user.

16. The combination according to claim 13 wherein said portion of said touch screen said first digit of a hand of a user maintains contact with and slides across is located below said virtual graphical keyboard.

17. The combination according to claim 13 wherein said virtual graphical keyboard can be swiped across by a digit of said user's hand to select at least one alternate set of commands for said graphical onscreen keys.

18. The combination according to claim 13 wherein said housing is a smartphone.

19. The combination according to claim 13 wherein said housing is a remote control device.

20. The combination according to claim 13 wherein said housing is a wristwatch.

21. The combination according to claim 13 wherein each time said user lifts said first digit of a hand of a user from said touch screen a space bar command is engaged.
